(19) United States
(12) Patent Application Publication
(10) Pub. No.: US 2011/0051406 A1
(43) Pub. Date: Mar. 3, 2011

(54) Star lite

(76) Inventor: Kevin John McLaughlin, San Francisco, CA (US)

(21) Appl. No.: 12/154,152

(22) Filed: May 21, 2008

(51) Int. Cl. F21L 4/02

(52) U.S. Cl. 362/184

(57) ABSTRACT

A self contained water proof, decorative, mystical star that projects extra bright, random light out of up to 5 of it's arms. Provides a universal mount to allow for as many possible uses in as many environments as possible. Placed on rods for use with particular holidays or events in but not limited to: floral arrangements, lawn borders and beach events. Worn as a necklace with supplied eye-screw for use in dry or wet environments such as but not limited to: dance parties, beach, pool, cruse ship events or as a hanging ornament. Floral wire can be used in universal mount via the eye-screw to twist tie STAR LITE to plants, tubing and other structures. Designed to float, be food safe and smooth surfaced which makes it well suited for but not limited to: fountains, punch bowls, in glasses, under buffet lighting or on wedding cakes.

### FIELD OF THE INVENTION

There is a demand for more diverse light-up designs especially star shaped a Glimmer's signature design. By adding a multi purpose, smooth, safe, waterproof, decorative, light-up, 5 leg star in a pillow like form we will be supplying a known demand.

More particularly, we hope to advance our company's existing line of light up decorative shaped devices into markets that require a safe waterproof product. Features incorporated, but not limited to, are: ability to be switched on and off externally, ability to be placed on elevation rods or ornamental stakes, or hung around neck as pendant or on tree or wreath as an ornament. It is water proof and buoyant so as to allow it to float in liquids and be sterilized. Because it is made of non toxic materials, is ultrasonically sealed and has a smooth surface, it is completely safe for use in and around food and drink. It provides for ultra bright light sources; allows; for custom light colors and is decorative whether on or off.

### BACKGROUND OF THE INVENTION

The image of a star especially the five armed “pentagram,” has long been respected as a sign of or standing for: excellence, achievement, power, mystery and love. Because of its use in many holiday and religious celebrations and ceremonies, it provides for a large market of star shaped decorations and devices.

Prior decorative stars including the many star shaped devices we have produced were never able to withstand moisture and were limited in the ways to mount or display them. This greatly limited use and range of sales.

Creating a mystical, pillow shaped star which embodies and reflects the feel and emotions of the above listed history of the image was foremost in our STAR LITE design. Previous designs have lacked the sense of mystery because the interior workings were sadly camouflaged.

STAR LITES were designed with attention on and with input from the demanding: floral, wedding, party and special event markets.

The STAR LITE can be packaged in with damp flora with no adverse effects. The STAR LIGHT can be used outdoors in the rain or snow or even be submerged in liquid for use in and around but not limited to: punch bowls, drink glasses, fountains, ponds, pools, lakes etc. This waterproof design allows us to sell to a wide audience from pool owners, water sports groups to the cruse ship industry. The waterproof design further provides for the device to be chemically sterilized for use in hospitals, senior centers, hospice and other areas where health risks are high. Sterilizing a traditional decorative star could easily destroy its finish and or short out or corrode its circuits. The fact that the switch and electronics are sealed inside the star device allows for safe use around oxygen and other flammable gasses and substances without fear of ignition, a major concern in hospitals. In summary; the STAR LITE we have designed has for the first time allowed a decorative light-up star to function properly in any climate or condition and is designed to open up new decorating opportunities replacing devices that only work well indoors and can not be used in or around liquid or food.

Furthermore the STAR LITE was intentionally designed to have a pillow shape with no sharp surfaces and therefore makes it very safe and user friendly.

Many prior star designs had one or more sharp edges to form the star shape. In the likely event a STAR LITE is licked or sucked on when used on cakes, or in liquids or drinks, the design's smooth surface is safe in the mouth. It has been our experience that not all products made for use in and around food and drink can make this claim. Many prior decorative star products had limited illumination, wither due to amount of light emitting devices provided or the brightness of said product. In addition, size and shape of the STAR LITE make it completely user friendly.

Traditional decorative star designs seldom take advantage of the latest high output light sources and those sources usually confine the light to lighting only the device itself at best.

The STAR LITE has been designed with the latest of super bright white LED's, equipped with light focusing lens tips to maximize illumination of the: feature, person, plant, structure, pathway or fluid surrounding the STAR LITE. The lenses allow for light to shine out further than was offered in the past.

From IC's random lighting patterns to the silicone particles filling the STAR LITE body cavity to the metallic glitter in the housing we have attempted to make the light source seem as mystical as possible and not found in many products.

In addition our product is provided with a universal mount that is key to making the STAR LITE truly universal. Most star shaped decorative products have a distinct purpose and trying to use said device in other than that specified by manufacturer can prove difficult, unsightly, hazardous or all together impossible.

We do not pretend to know all the applications our STAR LITES will be used for but want to list at least of few of the situations it was made to address using it with support stakes or with eye screws: If you want to line a drive or walkway, just push on a rod or stake and push other end into lawn. To hang on a tree branch? Just use a twist tie with the eye screw and attach to a branch. Adorn you fountain? Just toss a STAR LITE into the fountain. Wear a star to an event? Using eye screw put it on any suitable necklace material and eye screw and you have a pendant. Put it in a flower arrangement? Just push in a rod or stake in the star and mix in with the flowers. Use it on a cake as candles? Just place a star into frosting! We have been listening to our customers over the years and this product reflects their input and many of their requests.

It would be advantageous to provide a decorative, mystical, pillow shaped STAR LITE luminaire that can cover an almost unlimited number of uses or design needs for as many purposes situations and environments as possible without creating a separate device for each of those needs.

Environmentally adaptable, the STAR LITE is not adversely effected by rain, humidity or even when it is submerged in liquid. The device keeps working no matter how the weather changes or how is used including and not limited to use in; pools, ponds, fountains, punch bowls or drinks and would allow it to be shipped in with damp flora and arrive undamaged. Furthermore this air tight design allows it to be used in and around flammable gas or liquids so hospitals in particular could allow our device in and around oxygen and strong disinfectants in but not limited to; hospital patients rooms, rehab centers and hospice safely.

### SUMMARY OF THE INVENTION

In accordance with the present invention, there is provided a self contained, waterproof, light-up, pillow shaped star that is decorative and mystical either with power on or off. Intentionally buoyant when placed in liquid, the device is designed to project up to 5 randomly lit, bright light sources-radiating out of the arms outer edges from the central round circuit board. Said circuit board functions to hold the batteries on one side and IC and switch on opposite side designed so all will be center weighted in the center of the STAR LITE body consisting of two like star halves.

In accordance with this invention there is also provided a universal mount centered between two of the radiating star arms. This mount provides for pressure fit rods and stakes or for threaded screw fit use with eye screws to name a few. The universal mount was designed for as many uses as possible in as many conditions as possible, including but not limited to: floral arrangements, lawn boarders and path ways, fashion runways, sand castles and beach events. Use with pressure fit rods, floral stakes or threaded eye-screw for use with cords, ties, wires and lanyards.

The rods supplied for elevated use are metal but could be plastic, wood or other suitable material. Additionally covering rods with glitter or colored ribbon may is used to indicate particular holidays or events. Using a lanyard or cord supplied or purchased from a custom imprinted lanyard company, and eye screw makes it ideal for but not limited to wear around neck at beach or pool parties, cruse ship parties and other events. The eye screw increases STAR LITE's versatility allowing it to be used as an ornament or other hanging applications. We supply a silver eye screw but gold and brass other are available at any major hardware or jewelry store. Optionally floral wire or twist tie can also be used with eye screws to attach STAR LITES to plants, arches, wreaths, tubing, cables and other structures where other means are not practical. Further STAR LITES, by themselves, can be scattered on tables and used on table runners, in bowls of dry or damp treats, in and around festive food and drink!

### BRIEF DESCRIPTION OF THE DRAWINGS

A complete understanding of the present invention may be obtained by reference to the accompanying drawings, when considered in conjunction with the subsequent, detailed description, in which:

FIG. 1 is an exploded view of a STAR LITE containing:
1) waterproof boot actuator cover
2) on-off switch actuator pin
3) Upper half of STAR LITE half
4) actuator pin guide and seal
5) up to 5 focused, high output LED's
6) round circuit board with IC and switch contacts
7) bottom of STAR LITE half
8) balls of silicone or like material
9) spring actuator switch and contact on pc below
10) center weighted battery holder
11) universal mount;

FIG. 2 is a bottom perspective view of a view of a STAR LITE with floral stake or support rod universal adaptor option 1 (UA-1);

FIG. 3 is a top perspective view of a STAR LITE as a necklace using (p) pendant and option 2 eye-screw universal adapter (UA-2);

FIG. 4 is a front view of a STAR LITE with universal adapter (UA-2) the eye screw and floral wire or twist tie (t);

FIG. 5 is a front sectional of a body of liquid with a STAR LITE floating on top;

FIG. 6 is a perspective view of a STAR LITE to show it's pillow like form;

FIG. 7 is a graphic representation of illumination pattern;

FIG. 8 is an exploded view of magnified glitter in housing; and

FIG. 9 is a front perspective view showing top and front reference diagram.

For purposes of clarity and brevity, like elements and components will bear the same designations and numbering throughout the Figures.

### DESCRIPTION OF THE PREFERRED EMBODIMENT

Referring to the exploded view of the upper star half (FIG. 1-3) and lower star half (FIG. 1-7) with all its basic elements except for the additional optional mounting devices which achieves the additional range of uses.

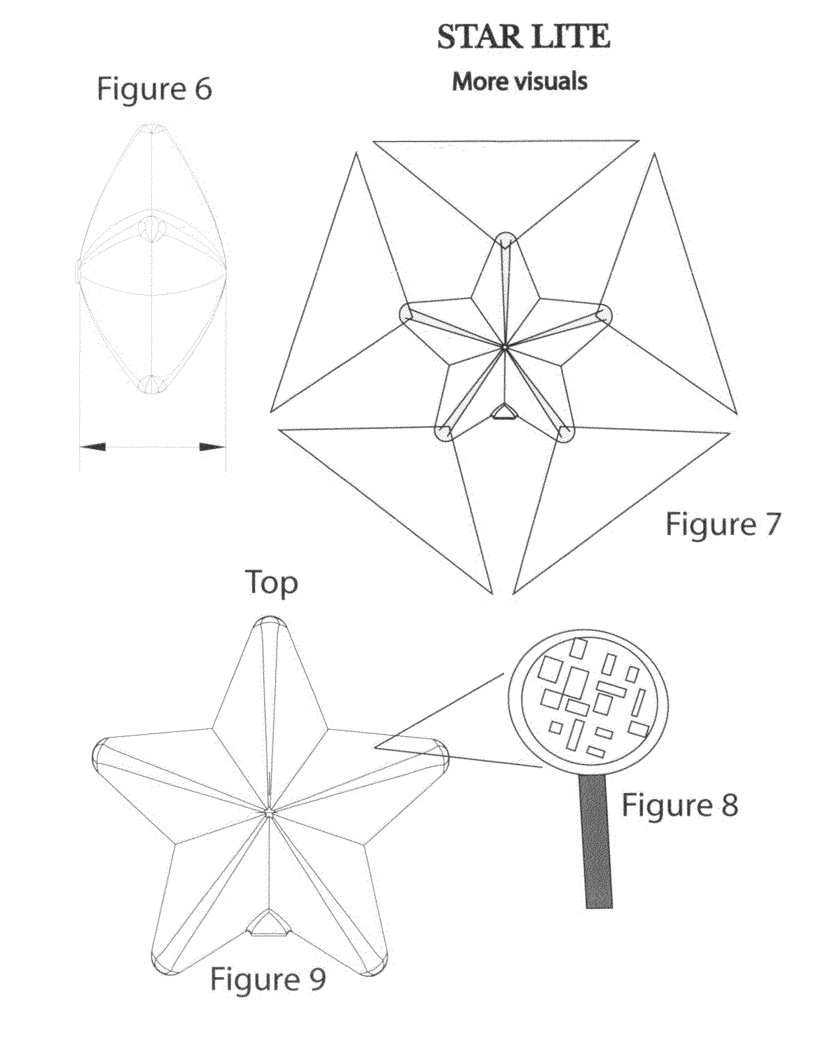

Since the STAR LITE can be used on several planes there is no true bottom please refer to exploded view (FIG. 1) and frontal view shown in (FIG. 9). Therefore we will use the bottom lower half (FIG. 1-7) of the STAR LITE as our descriptive starting point and from here on out refer to it as the bottom half of STAR LITE. The bottom half is designed to provide for five rounded pillow like arms (FIG. 6) creating five chambers and central cavity. For best effect, the housing material needs to be of a translucent, food safe plastic, nylon, resin or other suitable product that is shatter proof and solid enough to hold its form in normal room heat as well as be able to be frozen. The material selected need to provide for glitter (FIG. 8) to be dispersed evenly through its make up. The glitter along with the silicone fill material (FIGS. 1-8) is used to fill the STAR and adds greatly to it mystical appearance even when unit is not on.

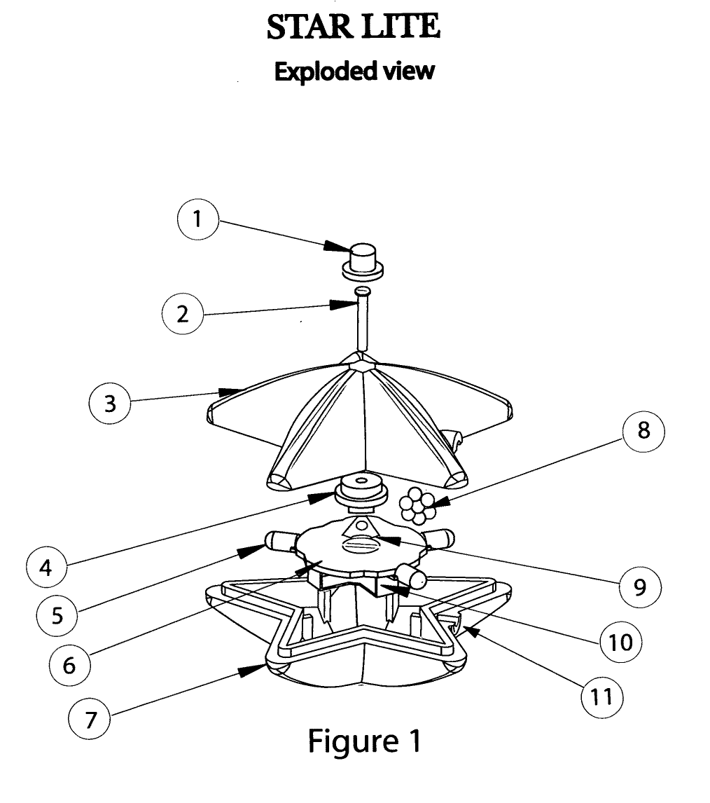

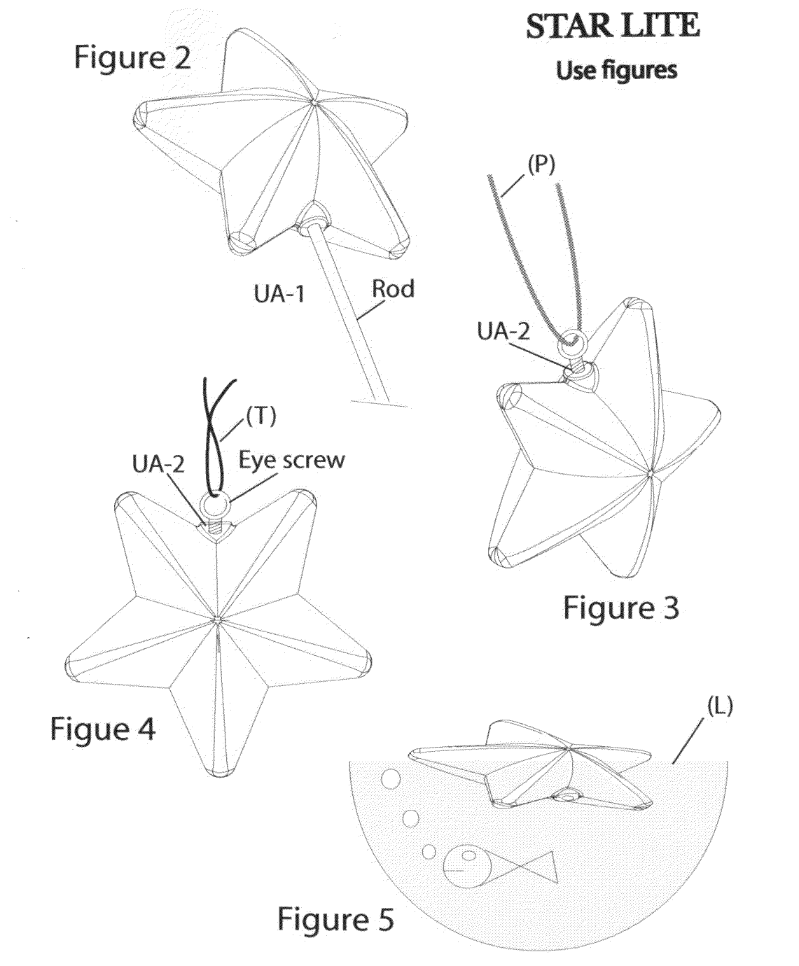

At the outer edge of the star half between two of the legs along the wall half a universal mount (FIG. 1-11) is created to accept the various mounting methods shown in (FIGS. 2 through 4). Installed into the cavity provided by the lower star half (FIG. 1-7), there is a round circuit board with IC (FIG. 1-6). This provides for the random light timing of the light sources and acts as the support for the LED's (FIG. 1-5) perfectly centered to shine out of the star arms for the best focused light coverage represented in (FIG. 7). As (FIG. 1) shows a battery holder (FIG. 1-10) is centered on the opposite side of circuit board from the device spring switch (FIG. 1-9) which comprises the contacts on the circuit board just under the spring switch (FIG. 1-6). The actuator pin (FIG. 1-2) transfers pressure to the spring switch (FIG. 1-9). The pin provided is metal but can be plastic or other suitable material. The actuator pin (FIG. 1-2) is covered with a water proof boot (FIG. 1-1) this boot is inserted from the inside opening of upper star half (FIG. 1-3) to make it more durable and water tight. Not only does the pin guide act as an O-ring on the pin, but when it is pressed into place the switch actuator pin 2 guide (FIG. 1-4) seals both sides of the boot lip against the star housing and guide, providing extra water proof security for the switch.

Batteries can be inserted in battery holder (FIG. 1-10), the round circuit board with IC (FIG. 1-6) can be placed into the lower half 7 (FIG. 1-7) with a silicone fill material 8 (FIG. 1-8) used to fill the air space of both halves. When the upper star half (FIG. 1-3) is ultrasonically sealed to lower star half (FIG. 1-7) we have a mystical, light up, waterproof star that can be switched on and off from the outside and is ready to be used by itself or with additional means through the STAR LITE's universal mount (FIG. 1-11) shown in further applications in FIGS. 2, 3, 4 and 5.

The STAR LITE is designed to have solid or hollow rod or floral stake option 1(FIG. 2 UA-1) to be used for elevated support in planters, flower arrangements, along pathways to name a few. Eye screw adapter option 2 (UA-2) as shown in FIGS. 3 and 4 for use with twist tie (FIG. 3-T) to attach to wreaths and arches and on end of chain or lanyard (FIG. 4-P) as a pendant. FIG. 5-L shows the device buoyant in liquid. (FIG. 7) shows front perspective of the STAR LITE's range and focused light source concept.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

I claim:

1. A decorative star-shaped translucent luminaire capable of safely illuminating and being immersed in beverages, swimming pools, fountains, or other wet environs, comprising:
a) a translucent, sealed outer shell having a general star shape with multiple arms;
b) one or more electronic light emitting devices positioned so that light is focused out from said arms;
c) an electronic control circuit and battery capable of providing said light emitting devices;
d) switching means for turning said control circuit on and off, said switching means being activated by squeezing said outer shell.

2. The luminaire of claim 1 wherein said outer shell is composed of soft, non-toxic plastic material free of sharp edges.

3. The luminaire of claim 1 wherein said outer shell contains glitter within its volume.

4. The luminaire of claim 1 wherein said star shape has 5 arms.

5. The luminaire of claim 1 wherein said light emitting devices are encapsulated light emitting diodes (LEDs).

6. The luminaire of claim 1 wherein said outer shell is furnished with a molded fixture with one or more eyelets that permit attachment of said luminaire to a stick or lanyard, or which permit's the chaining together of one or more luminaries.

7. The luminaire of claim 1 wherein said light emitting devices are incandescent lamps.

8. The luminaire of claim 1 wherein said outer shell is furnished with a molded fitting capable of attaching a rod or stick by pressure fit, or an eye screw by threading.
